(19) United States
(12) Patent Application Publication
(10) Pub. No.: US 2011/0320562 A1
(43) Pub. Date: Dec. 29, 2011

(54) Data Extraction System And Device

(75) Inventors: Sean L. Lane, Sykesville, MD (US); Alexander C. Watson, Laurel, MD (US)

(73) Assignee: Battlefield Telecommunications Systems, LLC, Columbia, MD (US)

(21) Appl. No.: 13/168,306

(22) Filed: Jun. 24, 2011

Related U.S. Application Data
(60) Provisional application No. 61/358,243, filed on Jun. 24, 2010.

(51) Int. Cl. G06F 15/16

(52) U.S. Cl. 709/217

(57) ABSTRACT

Disclosed is a data extraction system including a mobile target device including a storage device; a data extraction device to extract data from the storage device; a transfer path in which the extracted data travels from the data extraction device to a receiving device.

This is a non-provisional application of U.S. Provisional Patent Application No. 61/358,243, filed on Jun. 24, 2010, which is hereby incorporated by reference for all purposes as if fully set forth herein.

### BACKGROUND

1. Field of Invention

The present disclosure generally relates to data extraction. More specifically, the present disclosure relates to systems and devices which extract information from different media types.

2. Discussion of the Related Technology

Generally described, a computing device is a programmable device capable of receiving various inputs, and manipulating and storing data. A mobile device is a portable type of computing device that typically can also be used for communication. A mobile device is typically capable of retaining data relating to the device, a user of the device, and uses that the device has been put to. This data can be stored in various manners and locations on the device. During a forensic investigation, this data is often examined independent of the device itself. Unfortunately, conventional systems for forensically examining data or information stored on computing and mobile devices are cumbersome. This is typically due to the lack of standardized protocols for data storage and retrieval and for physical device connectivity. These conventional systems may be unnecessarily bulky in size and time-consuming to utilize. They may also have mixed support for mobile devices and may therefore be incompatible with some mobile devices.

### BRIEF DESCRIPTION OF THE DRAWINGS

The accompanying drawings are included to provide a further understanding of the disclosure, and are incorporated herein and constitute a part of this application. The drawings together with the description serve to explain exemplary embodiments of the present disclosure. In the drawings:

FIG. 1 illustrates a block diagram of an exemplary system capable of extracting data, according to embodiments of the disclosure;

FIG. 2 illustrates routines performed by a user of the system of FIG. 1 and exemplary components of a data receiving device, according to embodiments of the disclosure;

FIG. 3 illustrate routines and actions performed by a user of the system of FIG. 1 and exemplary components of a target device and data extraction device, according to embodiments of the disclosure; and

FIG. 4 illustrates a flow diagram of data extraction performed by exemplary components of the system of FIG. 1, according to embodiments of the disclosure.

### DESCRIPTION OF THE EMBODIMENTS

Advantages and features of the disclosure in part may become apparent in the description that follows and in part may become apparent to those having ordinary skill in the art upon examination of the following or may be learned from practice of the disclosure. The advantages and features of embodiments of the present disclosure may be realized and attained by the structures and processes described in the written description, the claims, and in the appended drawings.

It is to be understood that both the foregoing general description and the following detailed description are exemplary and explanatory and should not be construed as limiting the scope of the claims.

Reference will now be made in detail to the specific embodiments of the present disclosure, examples of which are illustrated in the accompanying drawings. Wherever possible, the same reference numbers will be used throughout the drawings to refer to the same or like parts.

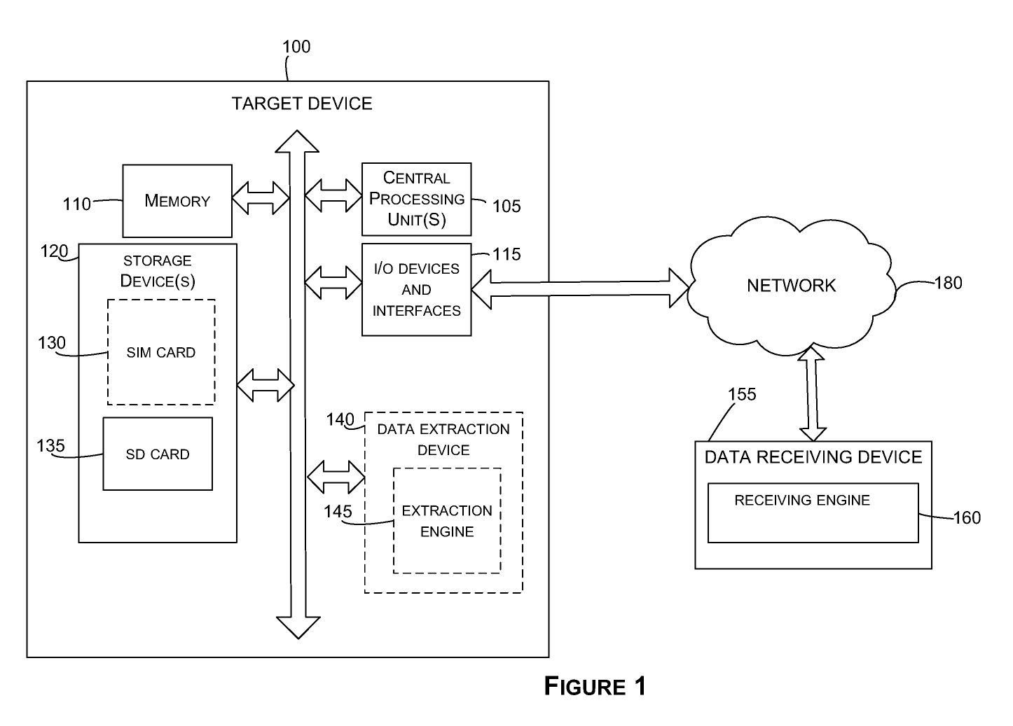

FIG. 1 illustrates a block diagram of an exemplary system capable of extracting data. As shown, a target device 100 communicates with a data receiving device 155 over a network 180. Communication within the system may take place over network 180 using sockets, ports, and other mechanisms known in the art. The communication may also be via wires, wireless technologies, cables, or other digital or analog techniques and devices to perform those techniques over a local area network (LAN), wide area network (WAN), personal area network (PAN), or the internet, for example. In an embodiment, communication may take place via Bluetooth, a cellular network, WiFi, 802.11, 3G, 4G, Enhanced Data rates for GSM Evolution (EDGE), Global System for Mobile Communications (GSM), Universal Mobile Telecommunications System (UMTS), Code Division Multiple Access (CDMA), 3GPP, 3GPP2, Zigbee, etc. Alternatively, communication within the system may occur without the use of a network 180 and may occur using various wires or cables, such as USB, serial bus, etc.

Target device 100 may be a computing system, such as a mobile device, mobile phone, smartphone, personal digital assistant (PDA), cellular phone, any device that uses a subscriber identity module (SIM) card, tablet computer, laptop computer, one or more computer servers or a peer-to-peer architecture, network device, and/or a biometrics device that captures finger prints, IRIS scans, latent prints, etc. For example, target device 100 can include any mobile device manufactured or running software made by Apple Computer, Inc. (e.g., an iPhone™ device), Research in Motion Limited (e.g., a Blackberry™ device), Google, Inc. (e.g., an Android™ phone) and/or or other computing devices as would be appreciated by one of skill in the art.

The target device 100 can include one or more central processing units (CPUs) 105, a memory 110, such as random access memory (RAM), to store information temporarily or permanently, one or more input/output (I/O) devices and interfaces 115, such as a network interface or card, touchscreen, keypad, keyboard, and the like to receive or transmit data. Components of target device 100 can be interconnected using a standards based bus system, such as Peripheral Component Interconnect (PCI), for example. Target device 100 may include various operating systems, hardware resources, and be on different network domains. The operating systems may manage the various hardware resources and provide a graphical user interface (GUI) or command line interface (CLI).

Target device 100 may further comprise one or more storage devices 120, such as target SIM card 130, SD card 135, microSD card, one or more hard drives, memory devices, USB flash drives, and/or one or more other media storage devices that store data and/or information as would be appreciated by one of skill in the art.

The storage device 120 generally includes one or more data repositories or media types having a variety of structured or unstructured content, such as file systems or databases of information from the target device 100 and/or data from a variety of networks, such as computer, cellular, WiFi, etc. that may be monitored or examined. In exemplary embodiments, storage device 120, such as SIM card 130 or SD card 135 may include data and information regarding AT commands (e.g., serial commands to command a target device 100, such as a cellular phone), contacts, address books, call history, call records (e.g, missed, sent, or received), International Mobile Equipment Identity (IMEI) (e.g., the hardware id of target device 100), model, firmware and vendor of target device 100, text messages (e.g, sent and received), Short Messaging Service (SMS) text messages, network providers (e.g., Verizon, AT&T, etc.), ringtones, applications, pictures, video, subscriber identity (IMSI), network operator, etc. In addition, SIM card 130 or SD card 135 may also include location information, such as, the mobile (e.g., target device 100) country code (MCC); mobile network code (MNC); location area code (LAC); cell ID of the mobile; network measurement results and broadcast control channel list (BCCH); current data, time, and time zone; current target device 100 language setting, timing advance, and the access technology of the target device 100.

Data extraction device 140 may be a SIM card, smart card, microcomputer, computing system, such as a mobile device, network device, one or more computer servers or a peer-to-peer architecture, or other device that can collect information or data from target device 100, such as the data described with respect to target device 100. The collected information (e.g, electronic data) from storage device 120 may be extracted from target device 100 by extraction engine 145, analyzed, encrypted, and/or transmitted to data receiving device 155 in order to extract intelligence regarding the target device 100 and/or networks (e.g., cellular) being monitored or analyzed. For example, the collected information may be analyzed as part of a forensic investigation. As illustrated, data extraction device 145 can be connected to target device 100 via a plug, jack, slot (e.g., SIM card slot, SD card slot, etc.), or other suitable interface. In some embodiments, data extraction device 140 can be a standalone device that communicates wirelessly or via wires using any of the methodologies described herein.

Target device 100 and other devices shown, such as data extraction device 140 and data receiving device 155, may include one or more engines or applications. Of note, target device 100, data extraction device 140, and data receiving device 155 may reside on physically separate machines or be on the same machine. In general, the word engine (used interchangeably with the word module, interface, or application), as used herein, refers to logic embodied in hardware or software instructions, which can be written in a programming language, such as Java™, C, C++, etc., for example. A software engine can be compiled into executable programs or written in interpreted programming languages, such as Perl or Visual Basic script. Software engines may be callable from other engines or themselves. Generally, the engines described herein refer to logical modules that may be merged with other engines or divided into sub-engines despite their physical organization. The engines can be stored in any type of computer readable medium or computer storage device and be executed by one or more general purpose computers. In addition, the methods and processes disclosed herein can alternatively be embodied in one or more engines or specialized computer hardware.

Of note, data extraction device 140 may include a SIM card, such as a microcomputer that stores a subscriber's identity (IMSI), Network Identification criteria, etc., in order to securely identify a user and authenticate the user to a telephony network. Data extraction device 140 may also be Java™ language enabled. In some embodiments where data extraction device 140 has limited memory and processing capabilities, data extraction device 140 may be configured to execute applications, such as extraction engine 145 on itself even though it may be connected to target device 100. This can advantageously allow a single extraction engine application to be written that is independent of the platform of the target device as opposed to having multiple extraction engine applications for each possible target device platform loaded on the same or several data extraction devices.

Various platform independent methodologies can be used to develop extraction engine 145. For example, data extraction device 140 may be Java Card™ enabled which allows it to run a subset of the Java language and provide a Java Card™ runtime environment. Data extraction engine 145 can extract data from target device 100 by copying the data onto data extraction device 140 or transmitting the data to a separate device, such as data receiving device 155. Other platform independent methodologies may also be utilized by extraction engine 145 of data extraction device 140, such as the SIM Tool Kit for 2G networks (STK), SIM Application Toolkit (SAT), Universal SIM Application for 3G networks (USAT). Data extraction engine 145 may include a STK and SAT based application, such as a Java™ applet, that implements multiple services to interact with target device 100 in order to implement secure over-the-air communication with data receiving device 155. Of note, data extraction engine 145 may use any wireless telecommunications standard (such as GSM, UMTS, LTE, etc.) to access data from various target devices 100 and SIM cards 130. For example, target device 100 may include a 2nd generation (GSM or CDMA device) or a 3rd or later generation (UMTS and LTE) device that includes a SIM card 130, such as a SIM card or universal SIM (U-SIM) card. In addition, data extraction device 140 may use a SIM ToolKit (STK) to extract data from a target device 100, such as a 2G device, and/or a SIM Application Toolkit (SAT) to extract data from a target device 140, such as a 4G device.

In addition, data extraction engine 145 may also include classes and methods from the 3GPP TS standards, such as the 43.019, 51.011, and 51.014 standards, in order to access GSM data and file systems, for example. It may be advantageous for data extraction device 140 to include or be a SIM card because standards such as 3GPP and GSM provide interfaces that enable SIM cards to run applications and universally access data, functions, and features on a mobile device, such as sent or received SMS messages, data sessions, etc. However, it is important to note that data extraction device 140 is not limited to a SIM card, and may include other smart cards, for example.

In exemplary embodiments, data extraction engine 145 may include an application that runs on any STK, Java Card™ enabled SIM, or universal SIM (USIM). Accordingly, data extraction engine 145 can be universally compatible with any GSM, UMTS, or Long Term Evolution (LTE) device, for example. Data extraction device 140 may include and/or use STK libraries in order to enable data extraction engine 145 to extract pertinent information from target device 100. Accordingly, data extraction device 140 can allow the elimination of the use of various cables, such as USB or serial cables, driver software, and/or a personal computer that may be used to extract data from target device. Particularly for users that may use conventional cell phone exploitation kits in the field, data extraction device 140 can greatly reduce the amount of equipment and time needed to extract data from target device 100.

A storage device can be made into a data extraction device 140 by addition of appropriate engines or applications. These engines and/or applications can be applied to the storage device through a direct connection or through a wireless connection made “over-the-air” (OTA). OTA is a technology used to communicate with, download applications to, and manage a SIM card without a physical connection to the storage device. One method is by sending a secure SMS message to a target device 100 that supports a SIMalliance Toolbox (S@T) compliant wireless internet browser (WIB). The WIB then initiates a data connection to the server identified in the SMS message and downloads an application or firmware update to be run locally on the target device 100. In an alternative method the updates can be delivered via TCP/IP over a cellular data connection. This method can be used with SIM cards and target devices that support Bearer Independent Protocol (BIP). In one embodiment, the user could work in conjunction with the network operator to deliver a Card Application Toolkit (CAT) application to a target device 100 over a wireless network using Bearer Independent Protocol (BIP), and Wireless Application Protocol (WAP). In another embodiment, the device could be connected to a private cellular network where the data extraction device would be installed directly to the storage device in the target device via an OTA update.

The system depicted in FIG. 1 provides the capability to shrink the size of a kit used to extract information from mobile devices from a suitcase full of mobile device interface cables and a powerful computer loaded with the requisite mobile device driver software for each type of target device 100. In accordance with the illustrated system, a kit in accordance with FIG. 1 may advantageously include a data extraction device 140 with a very small form factor, such as a 25×15 mm SIM card application, and/or a mobile device with a SIM card reader, such as a small embedded computer with minimal processing power. Compared to alternative cell phone forensic kits, the system of FIG. 1 provides reductions inform factor and an increase in ease of use. In addition, the illustrated system is capable of being compatible with any GSM, UMTS, and/or CDMA based mobile devices without requiring the use of any additional programming, driver software, or cables. For example, in the case of GSM-based mobile devices, data extraction device 140 may comprise a SIM card that can retrieve pertinent information from target device 100 using standard GSM requests to target device 100.

Once connected to target device 100, the data extraction device 140 may automatically execute data extraction engine 145 or run on startup of the target device 100. Alternatively, data extraction engine 145 may be a SIM-based application, for example, that a user can access through a menu on target device 100. As previously described, data extraction engine 145 may then use various Card Application Toolkit libraries, such as STK, SAT, and Java Card™ technology, for example, to download various data from target device 100 as described herein.

Data extraction device 140 may transmit or send information to data receiving device 155, such as the collected information described with respect to target device 100 above, or data which may be based on analysis of the collected information. Prior to transmitting the data, extraction engine 145 may encrypt the data. Data receiving device 155 may be a computing device, such as a mobile device or other microcomputer, tablet computer, laptop computer, one or more computer servers or a peer-to-peer architecture, network device, etc. In addition, data receiving device 155 may include a receiving engine 160 and can also include other components that are not shown, such as one or more central processing units (CPUs), a memory, such as random access memory (RAM), to store information temporarily or permanently, one or more input/output (I/O) devices and interfaces, such as a network interface or card, keyboard, touchscreen, keypad, slot to connect data extraction device 155 (e.g., a SIM card slot), a SIM card reader, and the like to receive or transmit data. Data receiving device 155 may further comprise one or more storage devices such as one or more hard drives, memory devices, or one or more other media storage devices that store data and/or information as would be appreciated by one of skill in the art. In addition, data receiving device 155 may be a networked device and accessible through a local cellular network, private cellular base station, or through wireless data transfer capabilities, such as BlueTooth or WiFi.

Receiving engine 160 can receive information and data from extraction engine 145 and allow data receiving device 155, to take actions based on the collected information or analysis of the collected information. Receiving engine 160 may be configured to send the collected information or analyzed information to other computing devices in various formats, such as a message, alarm, alert, etc.

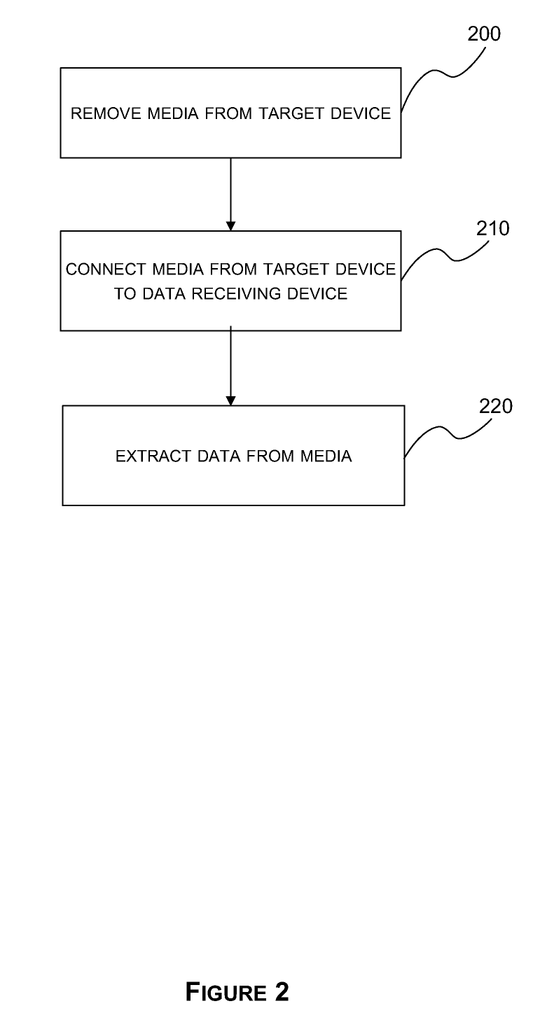

FIG. 2 illustrates routines performed by a user of the system of FIG. 1 and exemplary components of a data receiving device. In some embodiments, these routines can be performed by receiving engine 160 or other components of data receiving device 155. Depending on the embodiment, the method of FIG. 2 can include fewer or additional actions, and steps can be performed in an order which may be different than illustrated.

Beginning in block 200, removable media from the target device 100 can be removed from the device. The removable media may be a SIM card, SD card, microSD card, and/or other storage media that temporarily or permanently store data or information. Moving to block 210, the removable media from the target device 100 may be connected to the data receiving device 155. For example, in some embodiments when the media of the target device 100 may be a SIM card, the target SIM card may be inserted into a SIM card reader that communicates with a mobile device or other computing device. Alternatively, other media types, such as a SD card may be inserted into slots or readers capable of reading information from the respective media type.

At block 220, data may be extracted from the removable media of the target device 100. In exemplary embodiments, receiving engine 160 of data receiving device 155 may parse contents of the removable media and extract the information. The contents may include any of the data and information stored and utilized with respect to target device 100, including the data described with respect to the various storage devices 120. SIM card forensics software may be used to extract information, for example. In addition, if the user subsequently exfiltrates or sends data over from other storage devices of target device 100 using data extraction device 140, the contents from the removable media and other storage devices may then be matched up and combined to provide an aggregate picture of the contents of target device. In some embodiments, receiving engine 160 may also be configured to send out alerts or information depending on the contents of the extracted data to additional computing devices.

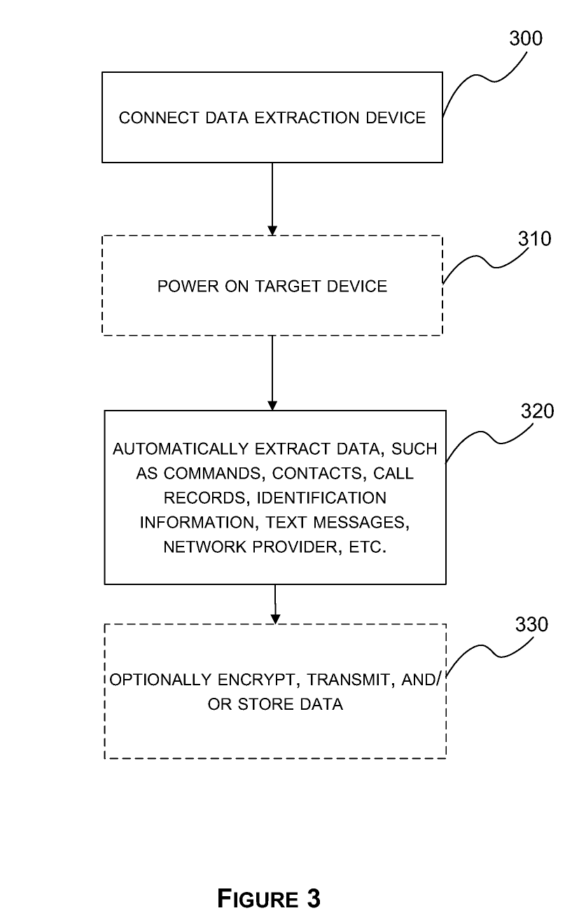

FIG. 3 illustrate routines and actions performed by a user of the system of FIG. 1 and exemplary components of a target device 100 and data extraction device 140. The exemplary routines can be stored as a process accessible by components of target device 100 or components of data extraction device 140, such as extraction engine 145. Depending on the embodiment, some of the actions described below can be removed, others may be added, and the sequence of the steps may be different.

Beginning in block 300, the data extraction device 140 may be connected to the target device 100. The connection can be made using any of the methodologies described herein, including a SIM card slot, Bluetooth, WiFi, cellular connection, etc. Moving to block 310, after the data extraction device 140 is connected to target device 100, the target device 100 may be turned on. Of note, if the target device 100 was previously not turned off this step may be omitted.

Continuing to block 320, various data may be extracted from the target device 100 including the data described with respect to FIG. 1 above, such as commands, contacts, call records, identification information, text messages, network provider information, etc. The data may be extracted from target device 100 by extraction engine 145 using the methods described herein, including Java Card™, CAT, SAT, and STK, for example.

Moving to block 330, the data may optionally be encrypted, transmitted to data receiving device 155, and/or stored directly on data extraction device 140, for example. The transfer of data may occur using the cellular connection of target device 100, such as GSM or UMTS, for example. For example, when a GSM or UMTS network may be available and extraction engine 145 is installed or configured within a valid data extraction device 140 (e.g., SIM card) from a local cellular provider, then extraction engine 145 can send data to data receiving device 155 wireles sly, for example. Once received, data receiving device 155 may store the sent data in a database that sorts data based on a key or identifier associated with a particular user or data extraction device 140 (e.g, SIM card), for example.

Data may also be sent to data receiving device 155 in sequences of SMS messages and/or be encrypted. For example, the data may be encrypted using a private key and sent in sequences of SMS messages and/or encrypted using a private key and sent over the general packet radio service (GPRS) or other data connection of target device 100. In some embodiments, if the target device 100 is a cellular phone and a specific network, known and private to the user is available, the data can be exfiltrated or extracted from the phone through the private network via a cellular data connection or SMS messages.

In addition, data may be sent using a protocol used in smart cards, such as bearer independent protocol (BIP) which may enable direct wireless access to data extraction device 140. For example, services like remote file management (RFM) and remote application management (RAM) can then be used to access forensic data collected from target device 100 directly from data extraction device 140 using any transmission methodology available on target device 100, such as Bluetooth, WiFi, Infrared Data Association (IrDA), GPRS, 3G, etc. Of note, extraction engine 145 may utilize, individually or in combination, any of the following standards and/or protocols: ETSI TS 102 223 Smart Cards, Card Application Toolkit (CAT); IETF RFC 793 Transmission Control Protocol (TCP), DARPA Internet; ETSI TS 102 124 Smart Cards, Transport Protocol for UICC based Applications; ETSI TS 102 127 Smart cards, Transport protocol for CAT applications; ETSI TS 102 223 Smart Cards, Card Application Toolkit; ETSI TS 102 225 Smart Cards, Secured packet structure for UICC based applications; ETSI ST 102 226 Smart Cards, Remote APDU structure for UICC based applications; 3GPP TS 23.048 Specification of security mechanisms for the SIM Application; 3GPP TS 31.115 Secured packet structure for (U)SIM Toolkit applications; 3GPP TS 31.116 Remote APDU Structure for (U)SIM Toolkit applications; and 3GPP TS 31.111 Specification of the USIM/SIM Application Toolkit for the SIM/ME, or any additional standards and/or protocols known in the field of art.

In some embodiments the extracted data may be stored directly on the data extraction device 140. If a GSM network is not available or the user does not wish to exfiltrate data across the local network (for security reasons, for example), then the user can elect to store the collected information to the internal memory of the data extraction device 140. Although the storage capacity of data extraction device 140 may be limited if it is a SIM card, it can advantageously still allow the user to store data.

In addition, if a Bluetooth or WiFi (e.g., 802.11) connection is available on target device 100, data extraction engine 145 can connect to the data receiving device 155. Once connected, data extraction engine 145 can rapidly exfiltrate or transfer data off of the target device 100 by activating a Bluetooth or WiFi chipset of target device 100 using AT commands (e.g, serial commands to command a phone that do not require authentication) via CAT libraries, for example.

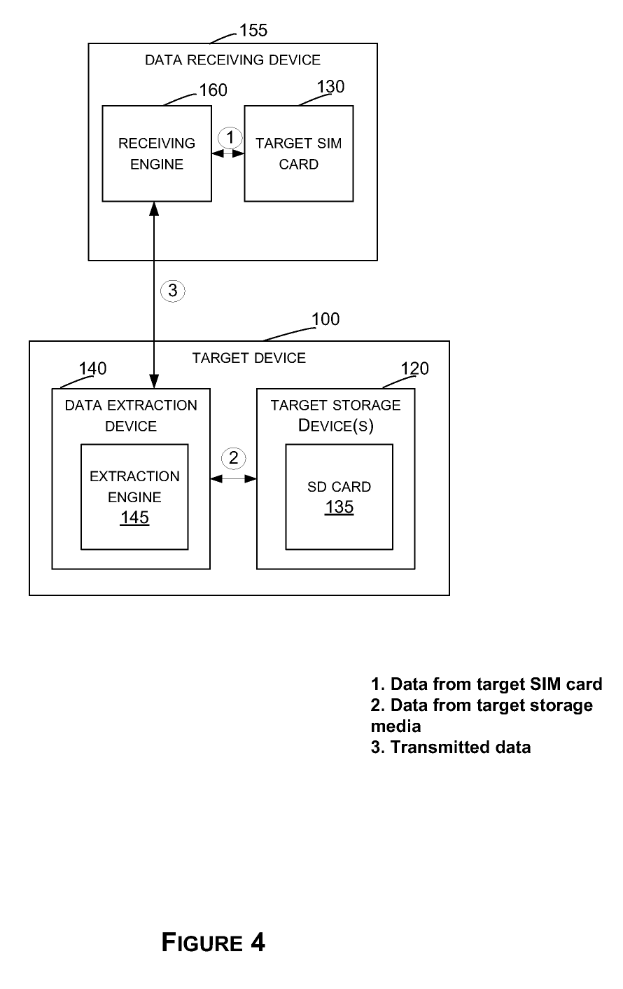

FIG. 4 illustrates a flow diagram of data extraction performed by exemplary components of the system of FIG. 1. In some embodiments, the illustrated routines can be performed by data receiving device 155, target device 100, data extraction device 140, and various components of these devices. Depending on the embodiment, the method of FIG. 4 can include fewer or additional actions, and steps can be performed in an order which may be different than illustrated.

Beginning in step 1, target SIM card 130 of target device 100 may be operably connected to data receiving device 155. Receiving engine 160 of data receiving device 155 may then extract data from target SIM card 130.

Moving to step 2, data extraction device 140 may be operably connected to target device 100. Extraction engine 145 may then extract data from any number of storage devices or media 120 of target device 100. As shown, one type of target storage device 120 may include a SD card 135.

Continuing to step 3, extraction engine 145 may then send the retrieved data to receiving engine 160 of data receiving device. The transmission of the retrieved data may occur via Bluetooth, WiFi, and other methodologies previously described herein.

It will be apparent to those skilled in the art that modifications and variations can be made in the present disclosure without departing from the spirit or scope of the disclosure. Thus, it is intended that the present disclosure cover any modifications and variations within the scope of the appended claims and their equivalents.

What is claimed is:

1. A data extraction device comprising:
an extraction engine configured to extract data from one or more storage devices of a target mobile device, and transmit the data to a data receiving device.

2. The data extraction device of claim 1, wherein the data extraction device comprises a subscriber identity module card.

3. The data extraction device of claim 1, wherein the data extraction engine stores at least a portion of the data in a memory of the data extraction device.

4. The data extraction device of claim 1, wherein the extraction engine is configured to run in a Java runtime environment.

5. The data extraction device of claim 1, wherein the extraction engine utilizes at least one mobile telecommunications standard to access Global System for Mobile Communications data from the target device.

6. The data extraction device of claim 1, wherein the extraction engine uses a Card Application Toolkit.

7. The data extraction device of claim 1, wherein the extraction is initiated at target mobile device start-up.

8. The data extraction device of claim 1, wherein the extraction is initiated by a remote command.

9. The data extraction device of claim 1, wherein the transmitted data is encrypted.

10. A computer-implemented method comprising:
retrieving data from one or more storage devices of a target mobile device; and
transmitting the data to a data receiving device.

11. The method of claim 10, wherein the data comprises one or more short message service messages.

12. The method of claim 10, wherein the data comprises telephone call records.

13. The method of claim 10, further comprising:
encrypting the data.

14. The method of claim 10, wherein the data comprises contacts from an address book.

15. The method of claim 10, wherein the data comprises location information including a country code.

16. The method of claim 10, wherein the data is transmitted to the data receiving device over a cellular network.

17. The method of claim 10, wherein the data is transmitted to the data receiving device over a personal area network.

18. The method of claim 10, wherein the data is transmitted to the data receiving device over a wireless area network.

19. The method of claim 10, wherein the retrieving step is initiated at device start-up.

20. The method of claim 10, wherein the retrieving step is initiated by a remote command.

21. A data extraction system comprising:
a mobile target device including a storage device;
a data extraction device to extract data from the storage device;
a transfer path in which the extracted data travels from the data extraction device to a receiving device.
